(19) United States
(12) Patent Application Publication
(10) Pub. No.: US 2002/0063043 A1
(43) Pub. Date: May 30, 2002

(54) Clamp system for conveyor belt skirtboard

(76) Inventor: Harold L. Herren, Platteville, CO (US)

Correspondence Address: Dean P. Edmundson, P. O. Box 710, Windsor, CO, 80550, US

(21) Appl. No.: 09/726,159

(22) Filed: Nov. 29, 2000

(51) Int. Cl. B65G 15/00

(52) U.S. Cl. 198/836.3

(57) ABSTRACT

A clamp system for use on a belt conveyer for securing and supporting rubber skirtboards from the skirt plates of the conveyor. The clamp system includes first and second stationary supports secured to the skirt plates, a press bar hinged to the lower end of each stationary support, and pressure adjustment means for applying force against the press bar to bias the press bar against one of the skirtboards. As the lower edge of the skirtboard wears away, the clamp can be loosened to enable the skirtboard to be moved downwardly toward the conveyor belt.

### FIELD OF THE INVENTION

This invention relates to conveyor belt systems for moving granular material such as sand, gravel, crushed rock, etc. More particularly, this invention relates to skirtboard systems for use in retaining granular material on a conveyor belt.

### BACKGROUND OF THE INVENTION

Conveyor belts are commonly used for transporting a variety of granular materials such as sand, gravel, crushed rock, etc. The conveyor belts are composed of rubber and they move over numerous supporting rollers. The side edges of the conveyor belt may be tilted or cupped upwardly slightly, but it is still necessary to include rubber skirtboards at the side edges of the belt to prevent the granular material from spilling off the sides of the belt.

These skirtboards must be made of rubber because the bottom edge of each skirtboard is in contact with the upper surface of the belt to provide a positive seal between the skirtboard and the belt. A metal or wood skirtboard would damage the conveyor belt as the belt moves relative to the stationary skirtboards.

The skirtboards are supported by the conveyor steel frame or shirt plate which extends downwardly to within several inches of the conveyor belt. It is important to avoid contact between the steel skirt plates and the belt in order to prevent damage to the belt.

The rubber skirtboards are composed of softer rubber than the rubber of the conveyor belt. Thus, the lower edges of the skirtboards contact the upper surface of the conveyor belt and are permitted to wear away without damaging the conveyor belt.

The skirtboard normally is provided in widths of about 4 to 10 inches and in thicknesses of 5/16 inch to one inch or more (e.g. two inches). The skirtboard may be provided in long rolls (e.g. 50 feet) which can be cut to the desired length.

A skirtboard clamp is used to attach the upper portion of the skirtboard to the skirt plate and to apply pressure to the outside of the skirtboard in opposition to the pressure of the material on the belt. As the lower edge of the skirtboard wears away, the clamps must be loosened to enable the skirtboard to be lowered to the conveyor belt.

Various types of clamp systems have been used previously. However, they have suffered from a number of disadvantages. For example, some clamps are cumbersome and difficult to use. Other clamp systems are not very effective in applying pressure to the outer edge of a skirtboard. See, for example, the clamps described in U.S. Pat. Nos. 3,989,137, 4,204,595, 4,436,446, 5,048,669, 5,154,280, and 5,267,642. See also UK patent application 2,087,337. None of such publications describe an effective clamp system having the features and advantages provided by the present invention.

### SUMMARY OF THE INVENTION

In accordance with the present invention there is provided a unique clamp system for use in securing and supporting a skirtboard from a skirt plate in a conveyor. The clamp system, in a preferred embodiment, comprises:

(a) first and second downwardly-extending stationary support means each having upper and lower ends or edges, wherein the upper end is secured to one of the skirt plates;

(b) a press bar hinged to the lower end of the support means; and

(c) pressure adjustment means such (as a bolt or a plurality of bolts) threadably secured to the lower end of the stationary support means to apply pressure against the press bar and bias the press bar against one of the skirtboards.

The rubber skirtboard is positioned between the press bar and the skirt plate on the conveyor. When the bolt(s) is rotated it applies force against the press bar which in turn tightly clamps the skirtboard to the skirt plate and prevents the skirtboard from moving relative to the conveyor or the skirt plate. The force is applied against the skirtboard near the lower edge of the skirt plate. This is highly advantageous because it causes the skirtboard to remain fairly rigid, it securely supports the skirtboard, and it enables almost all of the skirtboard to be used before it must be discarded.

Another advantage of the clamp system of this invention is that there is no need for a special clip or other accessory or holder to be applied to the skirtboard. Some other prior systems require a special clip to be attached to the upper edge of the skirtboard to which a clamp can be applied.

Further, the clamp system of this invention can be provided in any desired length. The clamp can also be easily cut on the job site to any required length.

The clamp system of the invention is also very compact. It can be easily welded to the outer surface of the skirt plate and it does not require much space. The clamp system can also accommodate skirtboards of various widths and thicknesses.

Other advantages of the clamp system of the invention will be apparent from the following detailed description and the accompanying drawings.

### BRIEF DESCRIPTION OF THE DRAWINGS

The invention is described in more detail hereinafter with reference to the accompanying drawings, wherein like reference characters refer to the same parts throughout the several views:

FIG. 1 is a cross-sectional view of a conveyor system utilizing the clamp system of this invention;

FIG. 1A is a cross-sectional view illustrating one of the clamp systems shown in FIG. 1; and

FIG. 2 is a perspective view of one of the clamps-shown in FIG. 1.

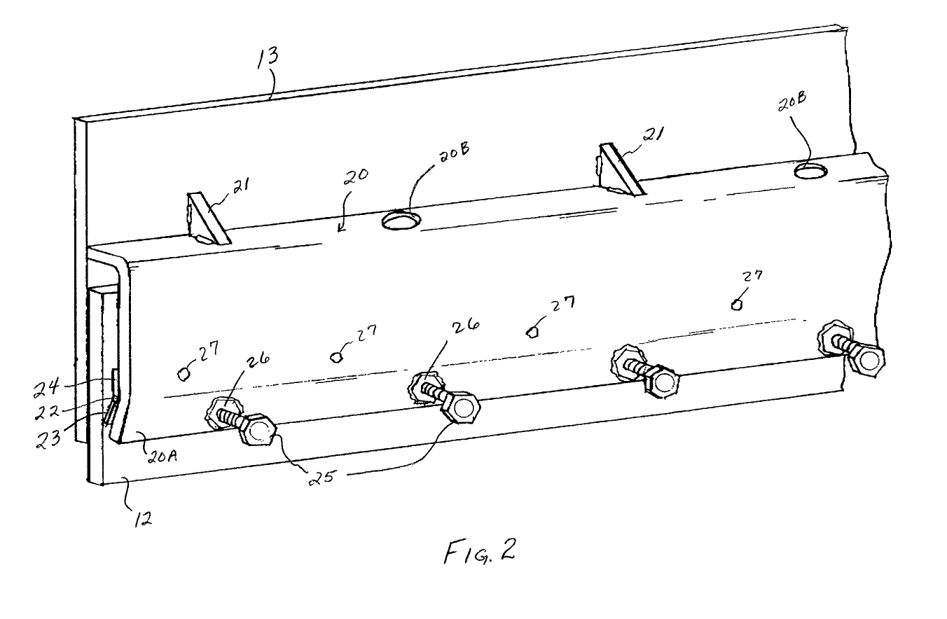

### DETAILED DESCRIPTION OF THE INVENTION

In the drawings there is shown a preferred embodiment of the clamp system for conveyor belt skirtboards. The conveyor belt 10 is composed of rubber and is useful for conveying loose granular material from one location to another.

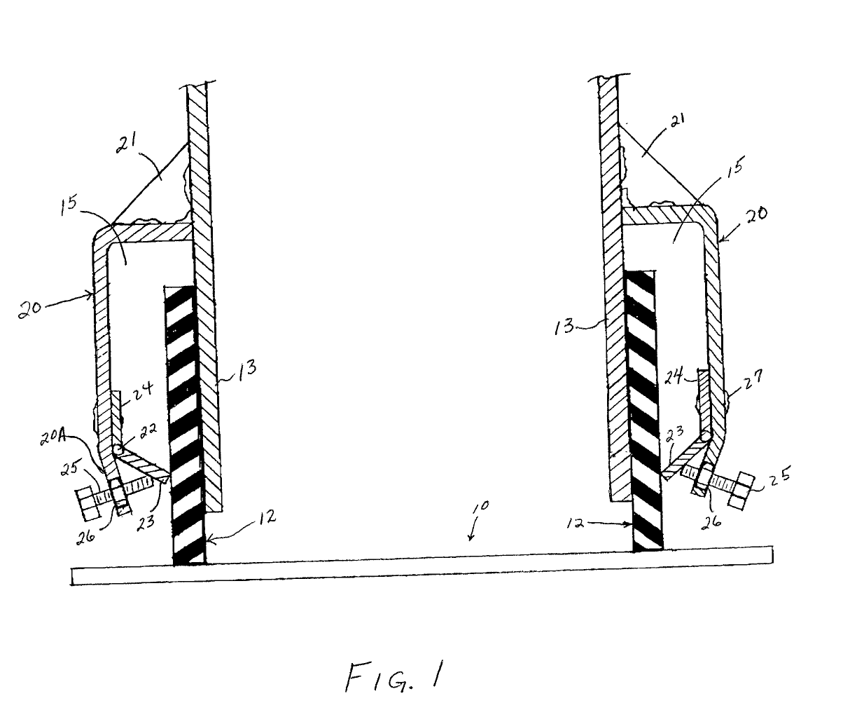

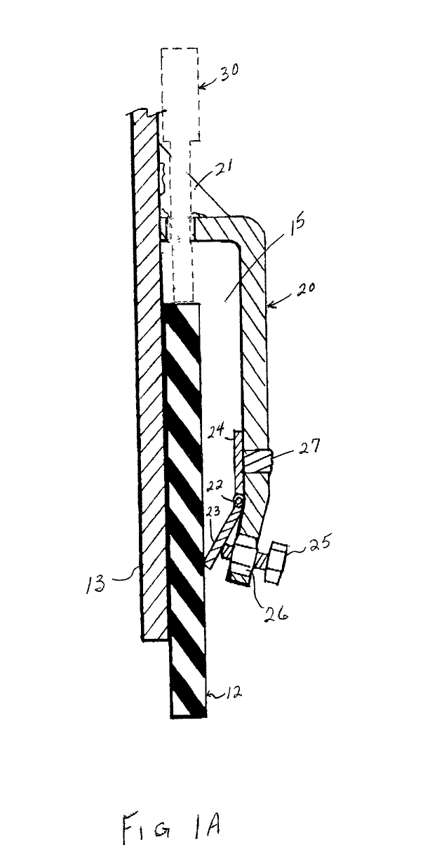

Rubber skirtboards 12 are clamped to, and extend downwardly from, the conveyor skirt plates 13 near opposite edges of the conveyor belt. One skirtboard edge extends down to, and is in close proximity to, one side of the conveyor belt, and the other skirtboard extends down to, and is in close proximity to, the other side of the conveyor belt, as illustrated in FIG. 1. The skirtboards prevent the loose granular material from falling off the side edges of the conveyor belt.

Each clamp includes (a) a stationary support member 20 whose upper edge is welded or otherwise secured to the skirt plate of the conveyor apparatus (and extends outwardly from the skirt plate), (b) a press bar 23 hingedly secured to the lower end 20A of the support member 20, and (c) a bolt 25 which is threadably secured to the lower end of the stationary support member. For example, a nut 26 can be welded to the lower end 20A of the stationary support member, and the bolt is threaded through the nut. When the bolt is rotated in one direction, the inner end of the bolt is forced against the press bar 23 (which causes the press bar to be pushed against the skirtboard 12 at an acute angle). This force effectively secures the skirtboard in a desired position. When the lower edge of the skirtboard wears away, the bolts 25 in the clamp can be loosened so that the skirtboard can be easily lowered to the desired position. Then the bolt can be tightened to again secure the skirtboard in its new position.

A channel 15 is defined between the support member 20 and the skirt plate 13. The rubber skirtboard of any desired thickness can therefore be positioned adjacent and parallel to the skirt plate as shown in the drawings. The support member extends downwardly from its upper end and is generally parallel to the skirt plate. There is no need for the support member 20 to extend below the lower edge of the skirt plate.

Because the stationary arm or member 20 extends downwardly from its upper end, the press bar 23 is located near the lower edge of the skirt plate. As a result, the clamp holds the skirtboard very securely near the lower edge of the skirt plate. This keeps the skirtboard in a fairly rigid condition for projecting downwardly from the skirt plate. This feature also enables the rubber skirtboard to be used virtually completely before discarding it.

Typically, several of the clamps are used along each skirt plate to secure and support the skirtboard. The clamps may be positioned close together or may be spaced apart, as desired. Also, each clamp may be of any desired length (e.g. 1 to 8 feet). It is also possible to weld or connect the ends of adjacent clamps, if desired, to create a very long clamp. It is also possible to cut the clamp in the field so as to make any desired length.

The height of the stationary support member 20 may vary. Typically, the height of each such member is several inches (e.g. 6-8 inches or more) so that skirtboards of varying height can be easily accommodated in the clamp.

The clamp must provide sufficient clearance between the skirt plate and the support member so that the clamp can accommodate skirtboard rubber of thicknesses from about 3/16 inch to 1 inch and widths from about 4 inches to 12 inches.

The clamp system of the invention can be easily and quickly installed on new or existing conveyors. Each clamp is simply welded onto the outside edge of a conveyor skirt plate. To provide additional strength, gussets or braces 21 may be welded or secured between the skirt plate and the upper edge of the support member, as shown.

In the embodiment shown in the drawings, the support member 20 comprises an angle iron which extends downwardly parallel to the skirt plate. Secured near the lower edge of the angle iron is a plate 24 including a hinge pin 22. Preferably the hinge is continuous along the full length of the clamp. Press bar 23 is attached to the hinge so that the press bar can pivot relative to the plate 24 and hinge pin 22. Thus, the press bar can be pivoted to an open position (away from skirt plate 13) to enable a skirtboard to be inserted into the channel between the support and the skirt plate. Plate 24 is preferably welded to support member 20. For additional securement, welds 27 can be provided through openings in support member 20, as illustrated in FIG. 1A.

The lower end or edge 20A of support member 20 is angled slightly toward the skirt plate and serves as support for the nut 26 and bolt 25. The bolt 25 is preferably generally perpendicular to the face or outer side of the press bar 23. The spacing between bolts 25 may vary but normally a spacing of about three to six inches is satisfactory.

The clamp system holds the skirtboard rubber solidly in position. The tightening bolt(s) 25 is located on the lower end of the stationary support member, as shown and illustrated. The hinged design of the clamp allows the maximum pressure to be applied to the press bar at the lowest possible area on the skirt plate. Clamp systems which apply pressure near or at the upper edge of the skirtboard rubber are not as effective in keeping the skirtboard rubber in a rigid condition. Also, the press bar is adapted to pinch the skirtboard rubber tightly (rather than simply compressing it). This is because the press bar contacts the skirtboard at an acute angle, as shown in the drawings.

The continuous hinge enables the clamp to be any length and the skirtboard is held securely in place along its full length. Even if the clamp is field-cut to a shorter length, because of the continuous hinge the clamp is still functional along its length.

The openings 20B along the top edge of support 20 enable a pusher rod 30 to be used to push the skirtboard downwardly (as illustrated in FIG. 1A) after loosening the bolts 25. This procedure avoids the need to fully loosen the bolts 25 when it is necessary to move the skirtboard downwardly. This saves time.

Other variants are possible without departing from the scope of this invention.

What is claimed is:

1. In conveyor apparatus of the type including a conveyor belt having first and second side edges, first and second skirt plates above said first and second side edges, respectively, and first and second skirtboards depending downwardly from said first and second skirt plates, respectively, the improvement which comprises a clamp system for securing and supporting said skirtboards from said skirt plates, wherein said clamp system comprises:
(a) first and second stationary support means each having upper and lower ends, wherein said upper end is secured to one of said skirt plates;
(b) a press bar hinged to the lower end of said support means; and
(c) pressure adjustment means carried by said lower end of said support means for applying force against said press bar and bias said press bar against one of said skirtboards.

2. Apparatus in accordance with claim 1, wherein said pressure adjustment means comprises a threaded bolt which is threadably attached to said support means.

3. Apparatus in accordance with claim 1, wherein said press bar includes an upper edge, and further comprising continuous hinge means extending along the full length of said edge to hinge said press bar to said lower end of said support means.

4. Apparatus in accordance with claim 2, wherein there are a plurality of said threaded bolts spaced along each said support means.

5. Apparatus in accordance with claim 4, wherein the length of said press bar is equal to the length of said support means.

6. Apparatus in accordance with claim 4, wherein said support means comprises an elongated member which is secured to said skirt plate by welding.
